(19) United States
(12) Patent Application Publication
(10) Pub. No.: US 2014/0053229 A1
(43) Pub. Date: Feb. 20, 2014

(54) Systems and Methods for Policy Propagation and Enforcement

(71) Applicant: Joseph Saib, Santa Clara, CA (US)

(72) Inventor: Joseph Saib, Santa Clara, CA (US)

(73) Assignee: AppSense Limited, Warrington (GB)

(21) Appl. No.: 13/586,338

(22) Filed: Aug. 15, 2012

(51) Int. Cl. G06F 21/00

(52) U.S. Cl. 726/1

(57) ABSTRACT

Many organizations want to extend the services and capabilities available to their users, but need to ensure that devices that are not within the perimeter and not under the direct control of the organization are managed in accordance with the organization's policies. A computerized method is disclosed for propagating resource access policies to a client device to provide compliance with security policies, comprising automatically receiving from a policy server via push communication at a client device a resource access policy comprising a trigger event and an action; when the trigger event is satisfied, executing the action; and sending an indication to the policy server that the resource access policy has been executed.

### BACKGROUND

Traditionally, corporate information such as files and resources have been managed and controlled via a perimeter-based security model. In such a model, a particular network (e.g., a network with an organization) is designated as a “safe” network, and access to information from sources outside the network (i.e., outside the “perimeter”) are limited. Access control ensures that only authorized information is able to cross the perimeter into the network. Authorized information is allowed to cross the perimeter into the network based on the source of an access request. If a request originates within the perimeter, the requestor is assumed to be authorized, and access is granted. If a request originates outside the perimeter, the requestor is assumed to be unauthorized, and access is denied. However, with the proliferation of devices, technologies, and services that make it easier to transport data and penetrate the perimeter, the perimeter-based security model becomes increasingly hard (if not impossible) to maintain. Administrators must make decisions about whether users may be allowed access to previously-protected information on user devices (e.g., desktop computers, laptop computers, tablet computers, cellular telephones such as smartphones) that are operated outside of the perimeter.

One way some corporations maintain a perimeter-based security model is via physical segregation. For example, most security sensitive organizations will maintain two physically separate infrastructures: an internal-only infrastructure and an externally-connected infrastructure. An internal-only infrastructure includes computers, networks, networking equipment and physical plant infrastructure that are not connected to the public Internet or any other external network. An externally-connected infrastructure has a similar infrastructure as the internal-only infrastructure, but is connected to the public Internet or other external network. An externally-connected infrastructure can be connected to the outside world via a limited number of access points. This limited accessibility can provide advantages, such as the ability to cut off access by severing the connection at the points of limited access. This arrangement can be successful in maintaining the perimeter-based security model. However, it cannot ensure that no security breaches will occur. For example, social engineering attacks or attacks by an employee or other person with privileged access are still possible.

Most organizations, however, desire to have control over resources and data stored outside the secure network perimeter. Currently-existing network protocols and architectures are limited in providing the ability to control resources and data outside the perimeter. For example, a typical problem encountered by organizations is that users may copy files from a secure, managed file server onto a user's local device for access outside of the perimeter, causing the organization to lose control over the files.

Based on the above, many organizations want to extend the services and capabilities available to their users, but need to ensure that devices that are not within the perimeter and not under the direct control of the organization are managed in accordance with the organization's policies.

### SUMMARY

In accordance with the disclosed subject matter, systems, methods, and non-transitory computer-readable media are provided for providing compliance with security policies.

The disclosed subject matter includes a computerized method for propagating resource access policies to a client device to provide compliance with security policies, the method comprising: identifying a resource access policy comprising a trigger event and an action for propagation to a client device, wherein the action controls the client device's access to resources; without a request from the client device for a resource access policy, sending the resource access policy to the client device to execute the action when the trigger event is satisfied; storing in a policy store first information identifying the resource access policy and the client device to which the resource access policy was sent; receiving an indication from the client device when the action associated with the resource access policy has been executed; and storing in the policy store second information indicating that the client device executed the resource access policy.

The disclosed subject matter also includes a policy server for propagating resource access policies to a client device to provide compliance with security policies, the policy server comprising: one or more interfaces configured to provide communication with a client device via a communication network; and a processor, in communication with the one or more interfaces, and configured to run a module stored in memory that is configured to identify a resource access policy comprising a trigger event and an action for propagation to a client device, wherein the action controls the client device's access to resources; without a request from the client device, send the resource access policy to the client device to execute the action when the trigger event is satisfied; store in a policy store first information identifying the resource access policy and the client device to which the resource access policy was sent, receive an indication from the client device when the action associated with the resource access policy has been executed, and store in the policy store second information indicating that the client device executed the resource access policy.

The disclosed subject matter further includes a non-transitory computer readable medium, where the medium has executable instructions operable to cause a policy server to: identify a resource access policy comprising a trigger event and an action for propagation to a client device, wherein the action controls the client device's access to resources; without a request from the client device, send the resource access policy to the client device to execute the action when the trigger event is satisfied; store in a policy store first information identifying the resource access policy and the client device to which the resource access policy was sent; receive an indication from the client device when the action associated with the resource access policy has been executed; and store in the policy store second information indicating that the client device executed the resource access policy.

The disclosed subject matter also includes a computerized method for implementing resource access policies from a policy server to provide compliance with security policies, the method comprising: automatically receiving from a policy server at a client device a resource access policy comprising a trigger event and an action, wherein the action controls the client device's access to resources; storing the resource access policy in a data store; monitoring at least one of user activity and system activity to determine when the trigger event is satisfied; when the trigger event is satisfied, executing the action; and sending an indication to the policy server that the resource access policy associated with the trigger event and the action has been executed.

The methods and systems can support a push communication method that comprises one of: connection keep-alive; long polling, extensible messaging and presence protocol (XMPP), hypertext transfer protocol (HTTP) server push, HTTP using JavaScript object notation (JSON), and HTTP using asynchronous JavaScript and extensible markup language (XML) (AJAX).

The trigger event can comprise one of: a timer; a startup of a specified application; a request for a specified file; user access for the specified file; user access for the specified file by a specified user; user access to at least one operating system capability; user access to network resources; user access to local resources; the user pressing a key; the user indicating that a trigger should be activated; logging out of the user's desktop environment; activation of a particular network resource; deactivation of the particular network resource; a receipt of the resource access policy; a receipt of another resource access policy; and a logical combination of trigger events.

These and other capabilities of the disclosed subject matter will be more fully understood after a review of the following figures, detailed description, and claims. It is to be understood that the phraseology and terminology employed herein are for the purpose of description and should not be regarded as limiting.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is an exemplary network connectivity diagram of a networked system in accordance with some embodiments of the invention.

FIG. 2 is an exemplary block diagram of a client device in accordance with some embodiments of the invention.

FIG. 3 is an exemplary block diagram of a policy server device in accordance with some embodiments of the invention.

FIG. 4 is an exemplary flow diagram for providing policy enforcement at a serve in accordance with some embodiments of the invention.

FIG. 5 is an exemplary flow diagram for providing policy enforcement at a client device in accordance with some embodiments of the invention.

### DETAILED DESCRIPTION

In the following description, numerous specific details are set forth regarding the systems and methods of the disclosed subject matter and the environment in which such systems and methods may operate, etc., in order to provide a thorough understanding of the disclosed subject matter. It will be apparent to one skilled in the art, however, that the disclosed subject matter may be practiced without such specific details, and that certain features, which are well known in the art, are not described in detail in order to avoid unnecessary complication of the disclosed subject matter. In addition, it will be understood that the embodiments provided below are exemplary, and that it is contemplated that there are other systems and methods that are within the scope of the disclosed subject matter.

The disclosed techniques enable an administrative user at an administrative console or device to create policies that are automatically downloaded from a centralized administrative server to individual user devices. The user devices can be configured to download the policies automatically, such that each new policy is “pushed” to the user devices, in some cases without the user device requesting the new policy. These policies, in turn, can be enforced by software on the individual user devices to control access to information technology resources. The following disclosure describes this policy framework.

Corporations and organizations can have an information technology (IT) infrastructure that is administered by one or more IT administrators. The IT administrator usually controls access to data using an administrative console or device to grant or deny access at a server to local and remote users, including members of the organization. The server may be a file server, such as a Common Internet File System (CIFS) server, or other resource that is controlled by the administrator. Alternatively, the server may be an authentication server that exists specifically to provide access control, such as a Remote Authentication Dial-In User Service (RADIUS) or Diameter server.

However, in some cases, the administrator may need to control access to secure data that is not stored at a server, but is instead stored locally on a client device, that is, on an individual user's personal or firm-issued device (e.g., personal desktop computer, laptop computer, tablet computer, cellular telephone such as a smartphone). When the secure data is stored on the user's device, the user can access the secure data at any time. To ensure that the user's access to the secure data conforms to the access privileges specified at the administrative user's device, the access privileges can be encoded in a policy or rule that can be interpreted or enforced by devices other than the server, for example, by the user's device. The system may need to have the operating system or application at the user's device cooperate to enforce this policy or rule locally.

In some embodiments, policies to control access for local or offline operations on the data can be enabled by sending the policies to the client device before the client device is taken offline. If the policies are not sent to the client device in a timely fashion, a user wishing to circumvent new security policies may disconnect from the network to avoid downloading new policies. This scenario may be prevented using a server that can push (or a client device that can pull) policies within a short time after the administrative user creates or modifies the policies at an administrative console and/or after the client device is connected to a network. The server may push policies to the client device without requiring any action to be performed by the user at the client device. The server may also push policies to the client device without giving control of the push process to the client device, such that the client device may not be able to refuse downloading policies, thereby preventing the client device from circumventing system-wide security policies. In some embodiments, server push technology is enabled by client polling at a lower network layer.

Policies may also be used to cause actions to be performed based on user- and/or administrator-configurable criteria. In some embodiments, the administrator can set up the policies. Policies can include at least one action and at least one trigger. Alternatively, policies can include any suitable number of actions and triggers. More than one action and/or more than one trigger can be joined by an AND, OR, NOT, or any other logical operation or combination of logical operations, or parentheses, to control the order of operations.

An action can be a command to be executed at the client device. Actions can include, for example: downloading files; deleting files; securely deleting files; denying user access to files; denying application access to files; requiring applications to open cache-only files locally; copying of files from one location to another; synchronization of one or more data stores, such as a contacts database or email database; encryption or decryption of files, emails, contacts, or other information; activation of whole-disk encryption; initiating user interaction for changing passwords or other security tokens; notification of one or more other users or administrators regarding activity by the user; or any other suitable action or combination of actions. A policy can include one or more actions. When combined with actions, policies provide a more powerful tool for managing the security and access configurations of user devices, and are particularly powerful as they are pushed to the user device without any interaction required by the user.

A trigger can be a condition that needs to be satisfied an action can be executed (i.e., the action may be executed based on the trigger). Triggers can include, for example, timers and time-based and/or calendar-based conditions that can include a specific date, a specific time, a periodic time (e.g., daily, weekly, month), or any suitable condition or combination of conditions. Triggers can also include, for example, startup of a specified application; request for a specified file; user access for a specified file or by a specified user; user access to certain operating system capabilities; user access to network resources or local resources; the user pressing a key or button; the user indicating that a trigger should be activated; logging out of a user's desktop environment; other triggers dependent on user input; the receipt of a new policy or any new information from a policy server; events elsewhere on the network, such as activation or deactivation of a particular network resource; or any other suitable trigger or combination of triggers. Triggers can also include the receipt of new policies. In other words, when a new policy arrives, it may specify that one or more actions should be performed immediately, at some predetermined time, in response to a trigger, or at any other suitable time. A policy can include one or more triggers.

An example of a policy having one action and one trigger is the following: “download an updated security configuration every Monday.” For this policy, the action is “download an updated security configuration” and the trigger is the calendar condition “every Monday.” Accordingly, this policy causes an updated security configuration to be downloaded to the client device (the action) every Monday (the trigger).

Another example of a policy having more than one trigger is the following: “if the user logs on and it's Tuesday, then delete all files.” For this policy, the action is “delete all files” and the two triggers are “if the user logs on” and “it's Tuesday.” Accordingly, this policy causes all files at the client device to be deleted (the action) only if the user logs on to the client device on a Tuesday (the triggers).

In some embodiments, the client device can initiate communication with the authentication server. For example, the client device can sent user identification information to the server. As another example, the client device can sent information specifying the operating system in use on the client device to the server. In response, the server can then, at any time thereafter, send one or more policies to the client device. These policies can be automatically pushed to, or can be sent in response to a request from, the client device. The policy can take the form of triggers and actions, as described above. These triggers and actions can be provided in any suitable format, such as XML, JSON, Javascript, or plain text, or any other suitable combination of formats.

The client device can evaluate all of its policies at designated circumstances, such as at login, at designated intervals or calendar intervals, upon receipt or modification of any policies, and/or any other suitable time, condition, or event, or any combination thereof. The client device can also use operating system functionality enabling interrupt processing to automatically evaluate policies at designated intervals. The client device may wake from sleep or from an energy-saving mode in order to contact the server and download new policies. In the event that the client device is a mobile device using a battery, the server may configure the client to download new policies only when a power source is connected. The server may also be in constant or intermittent contact with the client device, and may specify when the client device should contact the server, and may update the policies at any time, without any user interaction required or allowed at the client device.

For example, a user laptop may wake at 2:00 A.M. every night to download new policies from an administrative server. If an administrative user at an administrative console sets up a policy one week prior to a major system update that a system update should be performed on Sunday at 12:00 A.M., the user laptop may wake at 12:00 A.M. to download the system update, and again at 2:00 A.M., as configured by its list of policies.

Generally, information may be stored at the server, including information about the user; about user policies, including actions and triggers; about files; and about devices, including information about what policies are on what devices. Certain information can be maintained at the client device. For example, cached information may include cached files (those most recently looked at, or in some cases all files); username, password, policies previously acquired, user preferences, or any other suitable cached information or combination of cached information.

Policies may be combined. For example, a particular policy may incorporate two sub-policies. For example, the particular policy may be the following: “if condition A and condition B, then execute action C”. In this example, the two sub-policies are condition A and condition B.

In some embodiments, a data broker may be incorporated, such as is provided by the AppSense DataNow™ product. A data broker may be used in place of a local file system or networked file server to provide access to files. Whereas a file system provides an operating system with access to files stored on a local hard disk, and whereas a networked file server provides access to files stored on the file server to clients on the network, a data broker provides access to files that may reside either on the local system or on a remote system, but abstracts the actual physical location of the file, so that the client operating system does not know whether the file is local or remote. Using a data broker allows user files to be accessible across multiple operating systems (e.g., Windows, Mac OS X, Android, iOS and others), multiple devices (e.g., desktop computer, laptop computer, tablet computer, cellular telephone such as a smartphone), and in different networking environments (e.g., within a secure firewall, connected via a virtual private network, or on an unsecured network).

When used with a data broker, the policy described herein may still be used to provide or restrict access to files. A policy server may provide an authoritative source of policies that allows a client device to download policies. The policy server may also push policies to the client device, as described above. The data broker can implement access control of files according to any downloaded policies, such that if a file is available on the client device, the data broker checks all downloaded policies to determine whether to grant access to a local user. If a file is not available on the client device, and the network file server holding the file is not available, the data broker need not grant access to a local user regardless of any specified policies, because the file is not currently accessible.

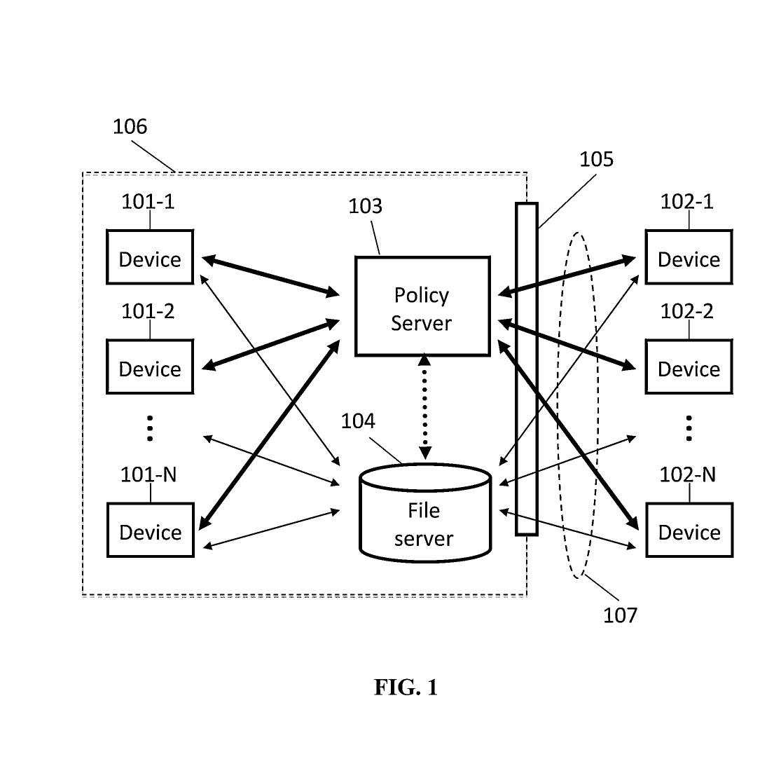

FIG. 1 is an exemplary network connectivity diagram of a networked system in accordance with some embodiments of the invention. Organizational network 106 includes devices 101-1, 101-2, . . . 101-N, policy server 103, and file server 104. Devices 101 can be networked together that allows any device 101 to communicate with one another device 101 internal to the organizational network 106 and/or to communicate with other devices (e.g., devices 102-1, 102-2, . . . 102-N) external to the organizational network 106. Devices 101 and 102 can be a desktop computer, laptop computer, tablet computer, cellular telephone such as a smartphone, printer, copies, fax machine, or any other suitable device or combination of devices. Devices 101 and 102 are owned and/or operated by users, for example, by employees, contractors, authorized third parties, and/or any other individuals authorized to access information from the organizational network 106. Organizational network 106 is protected by firewall 105, such that all nodes within organizational network 106 and behind firewall 105 are within the “perimeter” of the network. Devices 102 are located outside of the perimeter of the network and can communicate with organizational network 106 via a communication network 107. The policy server 103 is responsible for providing policies and controlling access to protected resources (e.g., controlling access to file server 104) to devices 101 and 102. Each device includes operating system software and also contains software that can receive, process, and enforces the policies from policy server 103. Each device 101 and 102 has access to information from file server 104, but this access can be controlled by policies from policy server 103. Different users and/or devices may have the same or different policies that control access to information within the organizational network 106.

The communication network 107 can include the Internet, a cellular network, a telephone network, a computer network, a packet switching network, a line switching network, a local area network (LAN), a wide area network (WAN), a global area network, or any number of private networks currently referred to as an Intranet, and/or any other network or combination of networks that can accommodate data communication. Such networks may be implemented with any number of hardware and software components, transmission media and network protocols. Although FIG. 1 represents the network 107 as a single network, the network 107 can include multiple interconnected networks listed above.

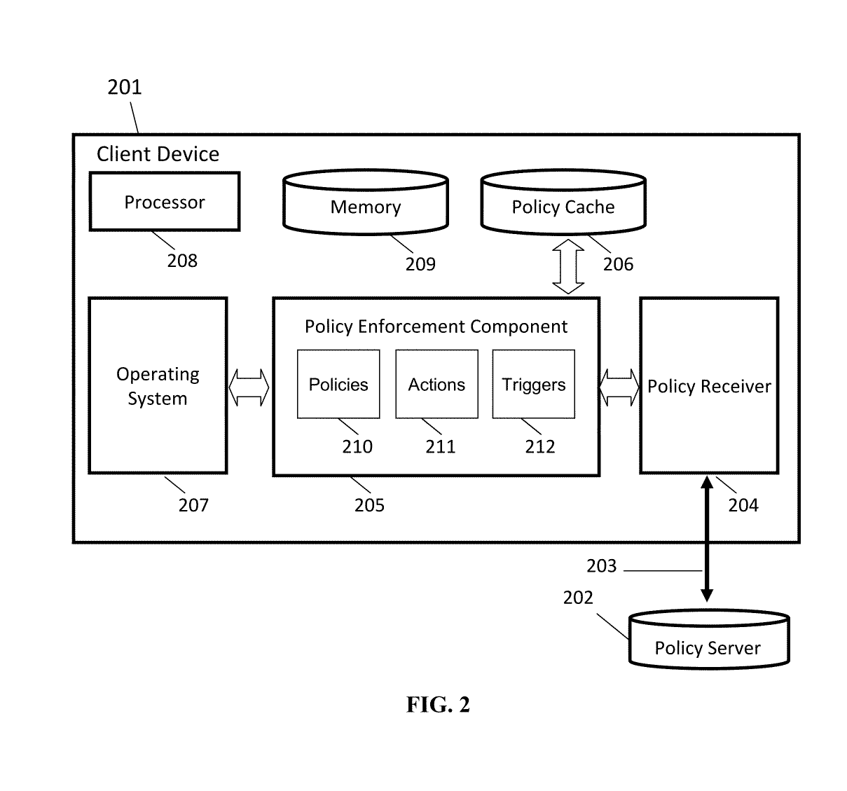

FIG. 2 is an exemplary block diagram of a client device in accordance with some embodiments of the invention. The modules in FIG. 2 are merely exemplary and that more, fewer, or any other combination of modules can be used. In FIG. 2, client device 201 (e.g., devices 101 and/or 102 from FIG. 1) includes a processor 208, a memory 209, a policy cache 206, an operating system 207, a policy enforcement component 205, and a policy receiver 204. Client device 201 can be devices 101 and/or 102 in FIG. 1. Processor 208 executes instructions for the operating system software and policy enforcement software. Memory 209 provides working memory for all of the processes described herein, and also provides storage for policies, triggers and actions. Policy cache 206 stores policies, triggers and actions that have been downloaded from a policy server (e.g., policy server 103 from FIG. 1). Operating system 207 provides essential software required to operate the client device, and may include modifications made to enforce access controls required by policies. Policy enforcement component 205 interoperates with operating system 207 and policy cache 206 to enforce policies, identify triggers and perform actions. Policy receiver 204 receives policies from a policy server, including pushed policies.

Policy enforcement component 205 can communicates with policy cache 206, operating system 207, and policy receiver 204. Policy receiver 204 can communicate with policy enforcement component 205, and use interface 203 to send and receive policy information to and from external policy server 202. Interface 203 may be a network interface, such as a wireless network interface, 802.11 network interface, wired network interface, Ethernet network interface, or other network interface. Interface 203 may also be a local interface with a local system, such as a PCMCIA bus, PCI bus, PCI Express bus, HyperTransport bus, or other suitable bus.

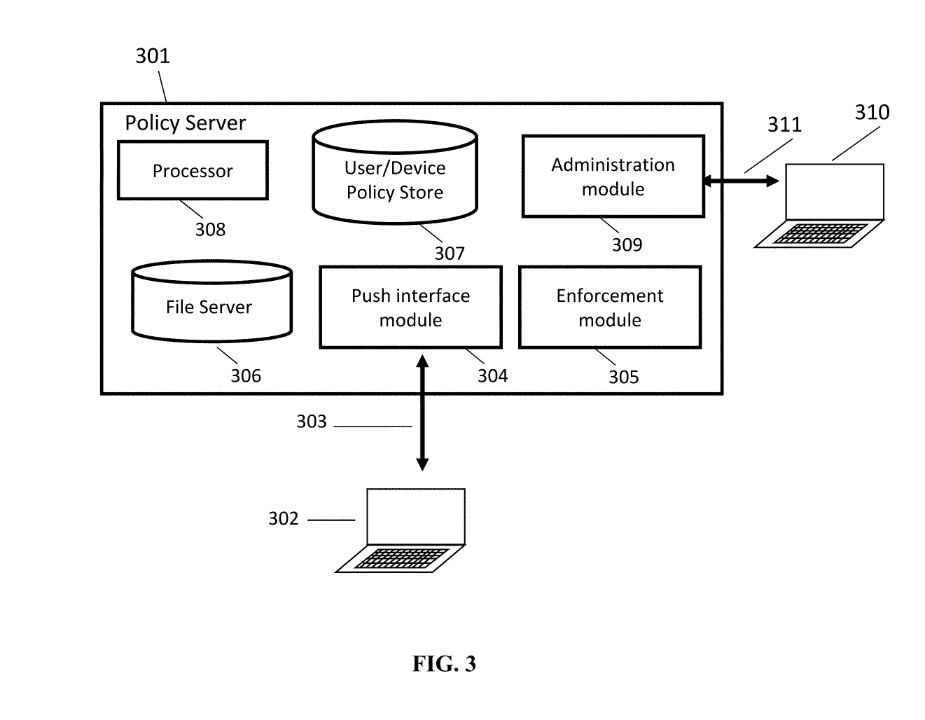

Policy server 202 (e.g., policy server 103 FIG. 1) is external to, and provides policies to, client device 201. Policy server 202 can push policies to client device 201. Alternatively, policy server 202 can send policies to client device 201 in response to a request from the client device 201. Policy server 202 can be, for example, a Microsoft Exchange server, a cell network policy server belonging to a wireless network provider, a policy server within a corporate intranet, or any other suitable policy server or combination of policy servers. Policy server 202 can also include policy server functionality as described in reference to FIG. 3 below.

The policy enforcement component 205 includes a policies module 210, an actions module 211, and a triggers module 212. Policies can include an action and a trigger. A set of potential actions can be maintained within actions module 211. A set of potential triggers can be maintained within triggers module 212. The set of policies, including associated actions and triggers, received from policy server 202 can be maintained in policies module 210. A set of currently-active triggers can be maintained at trigger module 212, such that a user-initiated event or other operating system event can cause one of the trigger conditions to be met, thereby initiating an action according to a policy.

When a policy is received from the policy server 202 at policy receiver 204, the policy receiver 204 checks with policy enforcement component 205 to see if the policy exists within policy module 210. If the policy does not exist, the policy is created and stored in policy module 210. If the required actions and/or triggers do not exist, the policy receiver 204 communicates with policy server 202 to obtain the required actions and/or triggers, or relays an error message to policy server 202. The actions and/or triggers can then be stored in the modules 211 and 212.

Policy enforcement component 205 is responsible for initiating execution of policies 210. One way in which it enables policy execution is by monitoring the operating system 207 to determine when trigger conditions are met for triggers that are part of the currently-active set. Triggers can include, for example, timers and time-based and/or calendar-based conditions that can include a specific date, a specific time, a periodic time (e.g., daily, weekly, month), or any suitable condition or combination of conditions. Triggers can also include, for example, startup of a specified application; request for a specified file; user access for a specified file or by a specified user; user access to certain operating system capabilities; user access to network resources or local resources; the user pressing a key or button; the user indicating that a trigger should be activated; logging out of a user's desktop environment; other triggers dependent on user input; the receipt of a new policy or any new information from a policy server; events elsewhere on the network, such as activation or deactivation of a particular network resource; or any other suitable trigger or combination of triggers.

Triggers are stored with policies at policy cache 206, but are processed by trigger module 212. Trigger module 212 identifies specific calendar events, network events, file access events, and other events, and communicates with operating system 207 to ensure that when the specific events occur, the trigger module is activated. When the trigger module is activated, the trigger module identifies the appropriate action(s) to which the trigger is associated via a policy, and passes processing to the policy enforcement component 205.

Common actions can include one or more of the following: Actions can include, for example: downloading files; deleting files; securely deleting files; denying user access to files; denying application access to files; requiring applications to open cache-only files locally; copying of files from one location to another; synchronization of one or more data stores, such as a contacts database or email database; encryption or decryption of files, emails, contacts, or other information; activation of whole-disk encryption; initiating user interaction for changing passwords or other security tokens; notification of one or more other users or administrators regarding activity by the user; or any other suitable action or combination of actions.

Processor 208 can be configured to implement the functionality described herein using computer executable instructions stored in a temporary and/or permanent non-transitory memory such as memory 209. Memory 209 can be flash memory, a magnetic disk drive, an optical drive, a programmable read-only memory (PROM), a read-only memory (ROM), or any other memory or combination of memories. The processor 308 can be a general purpose processor and/or can also be implemented using an application specific integrated circuit (ASIC), programmable logic array (PLA), field programmable gate array (FPGA), and/or any other integrated circuit. Similarly, policy cache 206 may also be flash memory, a magnetic disk drive, an optical drive, a programmable read-only memory (PROM), a read-only memory (ROM), or any other memory or combination of memories. Operating system 207 may be any operating system, including a typical operating system such as Windows, Windows XP, Windows 7, Windows 8, Windows Mobile, Windows Phone, Windows RT, Mac OS X, Linux, VXWorks, Android, Blackberry OS, iOS, Symbian, or other OS. Operating system 207 may include modifications to enable access control, such as modifications to prevent direct file access without circumventing access control for files.

FIG. 3 is an exemplary block diagram of a policy server device in accordance with some embodiments of the invention. The modules in FIG. 3 are merely exemplary and that more, fewer, or any other combination of modules can be used. The policy server 301 can serve the functions of policy server 202 in FIG. 2, and provides policies to client device 302. Policy server 301 can pushing policies to client device 302. Alternatively, policy server 301 can send policies to client device 302 in response to a request from the client device 302. Policy server 301 can includes a processor 308, a user/device policy store 307, a file server 306, an administration module 309, a push interface module 304, and an enforcement module 305. Processor 308 is described below. User/device policy store 307 stores policies that apply to one or more devices and/or users that use policy server 301 to provide policy enforcement. Push interface module 304 is for interfacing with user device 302 via network interface 303. Enforcement module 305 compares user credentials, including usernames, user IDs, and other user identification with policies stored in user/device policy store 307 to determine whether a given user may access a particular resource. Administration module 309 is responsible for allowing an administrative user at an administrative console 310 to create policies.

Policy server 301 serves to track and save available information about policies sent to users, including policies that have been previously pushed to the user. This information can be stored in user/device policy store 307. In some embodiments, a single user can have more than one device; in such cases, user/device policy store can store multiple device records associated with a single user.

Administration module 309 can be used by an administrative user at administrative console 310 to access policy server settings via interface 311. In particular, the administrative user can create policies, determine which policies should be sent to which users, determine when policies should be sent to the users, monitor what policies have been sent to which users, monitor what policies have been enforced, and monitor when policies have been enforced. Administration module 309 can, in turn, communicate with enforcement module 305, push interface module 304, and policy store 307 to enable these capabilities. Policies which are created by the administrative user at an administrative console may be sent to the policy store 307 and subsequently to user devices 302.

Enforcement module 305 can receive requests from administration module 309 to push policies to the user, can retrieve the requested policies from the policy store 307, and can send to the requested policies to push interface module 304 to push the policies to the user using user device 302 via network interface 303. Enforcement module 305 can also receive notifications from the client device 302 when a policy has been successfully received, and when a policy is triggered and an action is made to occur. When a policy is triggered this event can be reported to administration module 309, which allows an administrative user to see the event via an administrative interface at administrative console 310 via interface 311.

Push interface module 304 and enforcement module 305 can collaborate to enable policies to be sent to user device 302 via interface 303. A push mechanism can be used to send policies to the user device 302. Examples of push mechanisms include: requiring the user device to perform frequent or infrequent polling; long polling from the user device; leaving a connection open, such as a persistent HTTP or TCP connection; leaving a server application or daemon running on the client device to receive messages or requests from the server 301; or any other suitable mechanism or combination of mechanism. These mechanisms are coordinated by push interface module 304. It is possible in some embodiments for a push interface mechanism to be configured to penetrate or circumvent firewalls. One such way is to implement a tunneling protocol between a user device and an enterprise policy server within a firewall. This is effective in allowing policies to be quickly pushed to user devices that are not within the security perimeter of the organization. As many systems provide push transport services using pull mechanisms, the present disclosure is thus not meant to be limited to push mechanisms but is also meant to cover pull mechanisms, such as polling.

As described above regarding processor 208 and memory 209, processor 308 can be configured to implement the functionality described herein using computer executable instructions stored in a temporary and/or permanent non-transitory memory such as policy store 307. Policy store 307 can be flash memory, a magnetic disk drive, an optical drive, a programmable read-only memory (PROM), a read-only memory (ROM), or any other memory or combination of memories. The processor 308 can be a general purpose processor and/or can also be implemented using an application specific integrated circuit (ASIC), programmable logic array (PLA), field programmable gate array (FPGA), and/or any other integrated circuit.

Interface 303 and interface 311 can be the same interface or different interfaces. Interfaces 303 and 311 can allow policy server 301 to communicate with other systems, such as other devices on one or more networks, server devices on the same or different networks, or user devices either directly or via intermediate networks. Interfaces 303 and 311 can be implemented in hardware to send and receive signals in a variety of mediums, such as optical, copper, and wireless, and in a number of different protocols some of which may be non-transient.

Policy server 301 can operate using an operating system (OS) software. In some embodiments, the OS software is based on a Linux software kernel and runs specific applications in the server such as monitoring tasks and providing protocol stacks, although other operating system can be used. The OS software can allow server resources to be allocated separately for control and data paths. For example, certain packet accelerator cards and packet services cards can be dedicated to performing routing or security control functions, while other packet accelerator cards/packet services cards can be dedicated to processing user session traffic. As network requirements change, hardware resources can be dynamically deployed to meet the requirements in some embodiments.

The software in policy server 301 can be divided into a series of tasks that perform specific functions. These tasks can communicate with each other as desired to share control and data information throughout policy server 301. A task can be a software process that performs a specific function related to system control or session processing. Three types of tasks can operate within policy server 301 in some embodiments: critical tasks, controller tasks, and manager tasks. The critical tasks can control functions that relate to the server's ability to process calls such as server initialization, error detection, and recovery tasks. The controller tasks can mask the distributed nature of the software from the user and perform tasks such as monitoring the state of subordinate manager(s), providing for intra-manager communication within the same subsystem (as described below), and enabling inter-subsystem communication by communicating with controller(s) belonging to other subsystems. The manager tasks can control system resources and maintain logical mappings between system resources.

Individual tasks that run on processors in the application cards can be divided into subsystems. A subsystem can be a software element that either performs a specific task or is a culmination of multiple other tasks. A single subsystem includes critical tasks, controller tasks, and manager tasks. Some of the subsystems that run on policy server 301 include a system initiation task subsystem, a high availability task subsystem, a shared configuration task subsystem, and a resource management subsystem.

The system initiation task subsystem can be responsible for starting a set of initial tasks at system startup and providing individual tasks as needed. The high availability task subsystem can work in conjunction with the recovery control task subsystem to maintain the operational state of policy server 301 by monitoring the various software and hardware components of policy server 301. Recovery control task subsystem can be responsible for executing a recovery action for failures that occur in policy server 301 and receives recovery actions from the high availability task subsystem. Processing tasks can be distributed into multiple instances running in parallel so if an unrecoverable software fault occurs, the entire processing capabilities for that task are not lost. User session processes can be sub-grouped into collections of sessions so that if a problem is encountered in one sub-group users in another sub-group will preferably not be affected by that problem.

A shared configuration task subsystem can provide the policy server 301 with an ability to set, retrieve, and receive notification of server configuration parameter changes and is responsible for storing configuration data for the applications running within the policy server 301. A resource management subsystem can be responsible for assigning resources (e.g., processor and memory capabilities) to tasks and for monitoring the task is use of the resources.

In some embodiments, policy server 301 can reside in a data center and form a node in a cloud computing infrastructure. Policy server 301 can also provide services on demand such as Kerberos authentication, HTTP session establishment and other web services, and other services. A module hosting a client can be capable of migrating from one server to another server seamlessly, without causing program faults or system breakdown. A policy server 301 in the cloud can be managed using a management system.

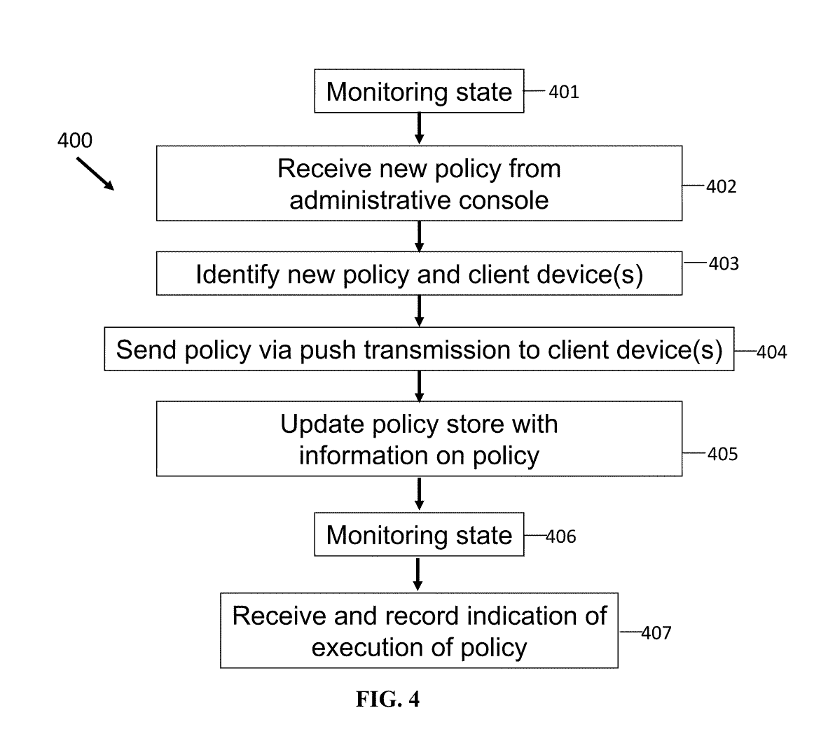

FIG. 4 is a flow diagram representing a process 400 for pushing policies to a user device from a policy server (e.g. policy server 103 in FIG. 1, 202 in FIG. 2, 301 in FIG. 3), in accordance with some embodiments. At step 401, the policy server is in a monitoring state, where it can receive new policies from an administrative user at an administrative console (e.g., administrative console 310 in FIG. 3) and for which a particular policy has not been set at the client device (e.g., client device 101/102 in FIG. 1, 201 in FIG. 2, 302 in FIG. 3). At step 402, the server receives a new policy from an administrative user at an administrative console. The new policy identifies at least one trigger and at least one action. In some embodiments, the administrative user can be prompted to select the triggers and actions from a list of triggers and actions that are available at the server. In other embodiments, the administrative user can be prompted to specify one or more new triggers and actions. The administrative user can then be prompted to create new policies using the new triggers and actions at the administrative console. The administrative user can also be prompted to select or specify which user or users, client device or devices, or any other suitable groups should receive the new policies.

At step 403, the server identifies that a new policy has been created and that the policy should be sent to a particular client device or devices. At step 404, the server initiates a push transmission of the policy to the target device(s) using any suitable push mechanism (e.g., via push interface module 304 in FIG. 3). At step 405, the server updates the policy store (e.g. policy store 307 in FIG. 3) with information about the policy and the target device(s). At step 406, the server returns to a monitoring state. At step 407, the server receives and records an indication from the client device that the policy has been executed. The server can record this in the policy store.

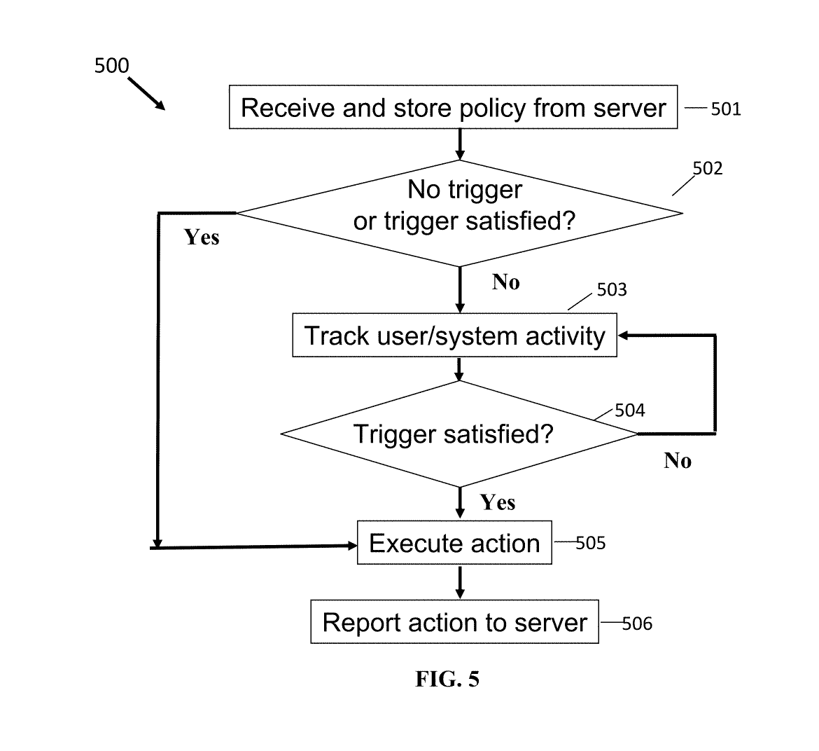

FIG. 5 is a flow diagram representing a process 500 for receiving and enforcing pushed policies at a client device (e.g., client device 101/102 in FIG. 1, 201 in FIG. 2, 302 in FIG. 3), in accordance with some embodiments. At step 501, the client device receives the policy from the server (e.g. policy server 103 in FIG. 1, 202 in FIG. 2, 301 in FIG. 3) and stores the policy in a local policy store (e.g., policy store 307 in FIG. 3). At step 502, the method determines whether the policy does not specify any trigger, or if the policy does specify a trigger, whether the trigger has been satisfied (or detected). If the policy does not specify any trigger, or if the policy does specify a trigger and the trigger has been satisfied, the client device executes the action associated with the policy at step 505. If the policy does specify a trigger and the trigger has not been satisfied, at step 503, the client device initiates tracking of user and system activity. The tracking is used to determine when a trigger is satisfied so that the policy action can be performed. At step 504, the client device determines whether the trigger is satisfied. If the trigger is not satisfied, the process returns to step 503. If the trigger is satisfied, the client device executes the action associated with the policy at step 505. The execution of the policy is reported to the server at step 506.

The subject matter described herein can be implemented in digital electronic circuitry, or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processor of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, (e.g., EPROM, EEPROM, and flash memory devices); magnetic disks, (e.g., internal hard disks or removable disks); magneto optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a CRT (cathode ray tube) or LCD (liquid crystal display) monitor, for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The subject matter described herein can be implemented in a computing system that includes a back end component (e.g., a data server), a middleware component (e.g., an application server), or a front end component (e.g., a client computer having a graphical user interface or a web browser through which a user can interact with an implementation of the subject matter described herein), or any combination of such back end, middleware, and front end components. The components of the system can be interconnected by any form or medium of digital data communication, e.g., a communication network. Examples of communication networks include a local area network (“LAN”) and a wide area network (“WAN”), e.g., the Internet.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

What is claimed is:

1. A computerized method for propagating resource access policies to a client device to provide compliance with security policies, the method comprising:
identifying a resource access policy comprising a trigger event and an action for propagation to a client device, wherein the action controls the client device's access to resources;
without a request from the client device for the resource access policy, sending the resource access policy to the client device to execute the action when the trigger event is satisfied;
storing in a policy store first information identifying the resource access policy and the client device to which the resource access policy was sent;
receiving an indication from the client device when the action associated with the resource access policy has been executed; and
storing in the policy store second information indicating that the client device executed the resource access policy.

2. The method of claim 1, further comprising sending the resource access policy to the client device using a push communication method.

3. The method of claim 2, wherein the push communication method comprises one of: connection keep-alive; long polling, extensible messaging and presence protocol (XMPP); hypertext transfer protocol (HTTP) server push; HTTP using JavaScript object notation (JSON); and HTTP using asynchronous JavaScript and extensible markup language (XML) (AJAX).

4. The method of claim 1, further comprising sending the resource access policy to the client device upon polling by the client device.

5. The method of claim 1, wherein the trigger event comprises one of: a timer; a startup of a specified application; a request for a specified file; user access for the specified file; user access for the specified file by a specified user; user access to at least one operating system capability; user access to network resources; user access to local resources; the user pressing a key; the user indicating that a trigger should be activated; logging out of the user's desktop environment; activation of a particular network resource; deactivation of the particular network resource; a receipt of the resource access policy; a receipt of another resource access policy; and a logical combination of trigger events.

6. The method of claim 1, wherein the action comprises one of: deleting a local file; denying access to a file; denying application access to a file; and requiring a file designated cache-only to be opened locally.

7. The method of claim 1, where identifying the resource access policy further comprises receiving the resource access policy via an administrative interface.

8. A policy server for propagating resource access policies to a client device to provide compliance with security policies, the policy server comprising:
one or more interfaces configured to provide communication with a client device via a communication network; and
a processor, in communication with the one or more interfaces, and configured to run a module stored in memory that is configured to:
identify a resource access policy comprising a trigger event and an action for propagation to a client device, wherein the action controls the client device's access to resources;
without a request from the client device for the resource access policy, send the resource access policy to the client device to execute the action when the trigger event is satisfied;
store in a policy store first information identifying the resource access policy and the client device to which the resource access policy was sent;
receive an indication from the client device when the action associated with the resource access policy has been executed; and
store in the policy store second information indicating that the client device executed the resource access policy.

9. The policy server of claim 8, wherein the module is further configured to send the resource access policy to the client device using a push communication method.

10. The policy server of claim 9, wherein the push communication method comprises one of: connection keep-alive; long polling, extensible messaging and presence protocol (XMPP), hypertext transfer protocol (HTTP) server push, HTTP using JavaScript object notation (JSON), and HTTP using asynchronous JavaScript and extensible markup language (XML) (AJAX).

11. The policy server of claim 8, wherein the trigger event comprises one of: a timer; a startup of a specified application; a request for a specified file; user access for the specified file; user access for the specified file by a specified user; user access to at least one operating system capability; user access to network resources; user access to local resources; the user pressing a key; the user indicating that a trigger should be activated; logging out of the user's desktop environment; activation of a particular network resource; deactivation of the particular network resource; a receipt of the resource access policy; a receipt of another resource access policy; and a logical combination of trigger events.

12. The policy server of claim 8, wherein the action is one of: deleting a local file; denying access to a file; denying application access to a file; and requiring a file designated cache-only to be opened locally.

13. A non-transitory computer readable medium having executable instructions operable to cause an apparatus to:
identify a resource access policy comprising a trigger event and an action for propagation to a client device, wherein the action controls the client device's access to resources;
without a request from the client device for the resource access policy, send the resource access policy to the client device to execute the action when the trigger event is satisfied;
store in a policy store first information identifying the resource access policy and the client device to which the resource access policy was sent;
receive an indication from the client device when the action associated with the resource access policy has been executed; and
store in the policy store second information indicating that the client device executed the resource access policy.

14. The computer-readable medium of claim 13, further comprising executable instructions operable to send the resource access policy to the user device using a push communication method.

15. The computer-readable medium of claim 13, wherein the trigger event comprises one of: a timer; a startup of a specified application; a request for a specified file; user access for the specified file; user access for the specified file by a specified user; user access to at least one operating system capability; user access to network resources; user access to local resources; the user pressing a key; the user indicating that a trigger should be activated; logging out of the user's desktop environment; activation of a particular network resource; deactivation of the particular network resource; a receipt of the resource access policy; a receipt of another resource access policy; and a logical combination of trigger events.

16. The computer-readable medium of claim 13, wherein the action is one of: deleting a local file; denying access to a file; denying application access to a file; and requiring a file designated cache-only to be opened locally.

17. A computerized method for implementing resource access policies from a policy server to provide compliance with security policies, the method comprising:
receiving from a policy server a resource access policy comprising a trigger event and an action at a client device without a request for the resource access policy from the client device, wherein the action controls the client device's access to resources;
storing the resource access policy in a data store;
monitoring at least one of user activity and system activity to determine when the trigger event is satisfied;
when the trigger event is satisfied, executing the action; and
sending an indication to the policy server that the resource access policy associated with the trigger event and the action has been executed.

18. The method of claim 17, further comprising sending the resource access policy to the client device using a push communication method.

19. The method of claim 17, wherein the trigger is one of: a timer; a file access request; a network resource access request; a local resource access request; a calendar condition; a logon request; a receipt of the resource access policy; a receipt of another resource policy; and a logical combination of trigger events.

20. The method of claim 17, wherein the trigger comprises a logical combination of multiple triggers, and wherein the action is one of: deleting a local file; denying access to a file; denying application access to a file; and requiring a file designated cache-only to be opened locally.
